(19) United States
(12) Patent Application Publication
(10) Pub. No.: US 2011/0284435 A1
(43) Pub. Date: Nov. 24, 2011

(54) FLUID FILTER

(76) Inventors: Erich Hanno Moser, Kalgenfurt (AT); Adolf Markus Ramusch, Wolfsberg (AT); Thomas Rudolph, Stuttgart (DE)

(21) Appl. No.: 13/112,694

(22) Filed: May 20, 2011

(30) Foreign Application Priority Data
May 21, 2010 (DE) 102010021252.0

(51) Int. Cl. B01D 35/00

(52) U.S. Cl. 210/120

(57) ABSTRACT

A fluid filter may include a collecting chamber for collecting separated fluid and a draining device having an elongated protrusion projecting into the collecting chamber. The draining device, in response to being in an open state, may allow air to flow into the collecting chamber for reducing a surface tension of the fluid.

The present invention relates to a fluid filter, in particular a fuel filter, with a collecting chamber, in particular with a water collecting chamber for collecting separated fluid, preferably water, and with a draining device, for example a drain valve or drain screw for draining the separated fluid, for example water, according to the preamble of the claim 1. Furthermore, the invention relates to a drain valve for such a fluid filter.

From DE 38 82 270 T2, a generic fluid filter is known which has a drain valve and a vent valve arranged separately thereto.

Fuels, in particular diesel fuels, but also oils always have a portion of water which is not entirely eliminable but has to be removed, if possible, prior to the combustion in an internal combustion engine so as to prevent, on the one hand, corrosion damage in the internal combustion engine and, on the other, to achieve an effective combustion. Usually, the water is separated in fuel filters and/or coalescers and collected in water collecting chambers connected thereto. Draining the separated water can take place automatically or manually, wherein in particular the intermolecularly acting forces of the separated water often make it difficult to drain without problems. The intermolecular forces are based on electrical attractive forces between atoms and molecules, wherein said forces in case of a molecule within the fluid act uniformly from all sides so that they cancel each other out there. However, in case of a water molecule on a surface, these interaction partners are absent so that this results in a force that stands perpendicular to the surface. In order to overcome said forces, a corresponding work has to be carried out, for example to separate a molecule from the surface.

The present invention is concerned with the problem to provide for a fluid filter of the generic kind, an improved embodiment which allows in particular a simplified, fast and problem-free draining of separated water.

This problem is solved according to the invention by the subject matters of the independent claims. Advantageous embodiments are subject matter of the dependent claims.

The present invention is based on the general idea to reduce a surface tension of a fluid, in particular of a separated fluid, in particular water, to be drained from a fluid filter, and thereby to facilitate discharging the same from the fluid filter. Hereinafter, the fluid to be drained is preferably to be understood as water because the latter represents the most common fluid to be drained, wherein generally also another fluid can be separated and drained. Hereinafter, throughout the entire application, reference is made to a water collecting chamber and the fluid to be drained refers to water to be drained, whereby this serves only for a better understanding and is of course not intended as limitation so that the water collecting chamber is to be understood only as a possible example for a collecting chamber and the water is to be understood only as a possible example for a fluid to be drained. The fluid filter which can be configured, for example, as fuel filter comprises in a known manner a water collecting chamber for collecting water separated from the fluid, in particular from the fuel, as well as a draining device for draining the separated water. In the open state, the draining device is able according to the invention to allow an air flow into the collecting chamber/water collecting chamber and, in addition, has an antenna-like, elongated protrusion, e.g. in the form of a lance or arrow, which is arranged at the end projecting into the water collecting chamber and moves, for example rotates and shifts when the draining device opens, thereby reducing the surface tension of the water. Reducing the surface tension is carried out by deforming, for example expanding the surface and/or introducing a shear force by rotating the protrusion which facilitates draining the separated water. Hereby, the protrusion penetrates into the volume of the separated water or is located therein and reduces the surface tension of the water, wherein the term “protrusion” summarizes of course all bodies such as, for example, pins, spikes, etc. by means of which an enlargement of the water surface and thus a reduction of the surface tension of the water can be achieved. A protrusion configured in such a manner which forms, for example, an axial protrusion (preferably straight or bent) of a valve piston of the draining device, can be manufactured and constructed in a simple and thus cost-effective manner, wherein the effect to be achieved therewith positively influences the draining behavior of the separated water. The protrusion can have a cross-section which is tapered toward the free end and is preferably formed round, twisted or, for example, star-shaped. Depending on the requirements, the shape of the protrusion is freely selectable. It is also possible to retrofit the protrusion to existing or already produced draining devices. Said protrusion can be made from a hard or flexible material. In particular when withdrawing the protrusion from the separated water, a capillary effect on the same generates a disturbance of the surface tension thereby facilitating a fast draining.

In an advantageous further embodiment of the solution according to the invention, the draining device has a valve piston having a second external thread which can be screwed into a second internal thread arranged on a housing of the draining device. At the same time, said housing has a valve seat in which the valve piston having a valve section can be translationally displaced by rotating the same. Precisely this rotation which also takes place when opening the draining device, together with the withdrawing movement, facilitates the reduction of the surface tension. The antenna-like, elongated protrusion is preferably arranged on the front side on the valve section of the valve piston or is formed integrally with the same. By rotating the valve piston relative to the housing of the drain valve, thus, a translational displacement of the valve section within the valve seat takes place, wherein upon a further rotational movement of the valve piston, the valve section is drawn out of the valve seat and thereby, the drain valve is opened. Sealing the valve section in the hollow-cylindrically formed valve seat of the housing is usually carried out via a first O-ring seal. The valve piston as well as the associated housing with the valve seat can preferably be formed as plastic part, wherein it is theoretically conceivable that the antenna-like, elongated protrusion is formed onto the front side of the valve section of the valve piston and is in particular formed integrally with the valve piston.

In a further advantageous embodiment of the solution according to the invention, an axial extension of the valve seat on the housing side is smaller than the axial extension of a second external thread via which the valve piston is screwed to the housing so that the drain valve is fully opened, that is, that the valve section of the valve piston is completely pulled out of the valve seat so as to provide a maximally possible stroke for reducing the surface tension before the valve piston can be completely removed from the housing of the drain valve. This ensures that it is possible to drain the separated water without the need to completely remove the valve piston from the associated housing. The two external threads have the same thread direction, for example are both right-hand threads, wherein the two external threads are formed to be differently stiff. Usually, the second external thread runs smoother than the first external thread.

Further important features and advantages of the invention arise from the sub-claims, from the drawings, and from the associated description of the figures based on the drawings.

It is to be understood that the above mentioned features and the features yet to be explained hereinafter can be used not only in the respectively mentioned combination but also in other combinations or alone without departing from the context of the present invention.

Preferred exemplary embodiments of the invention are illustrated in the drawings and are explained in the following description in more detail, wherein identical reference numbers refer to identical, or similar, or functionally identical components.

In the figures, schematically:

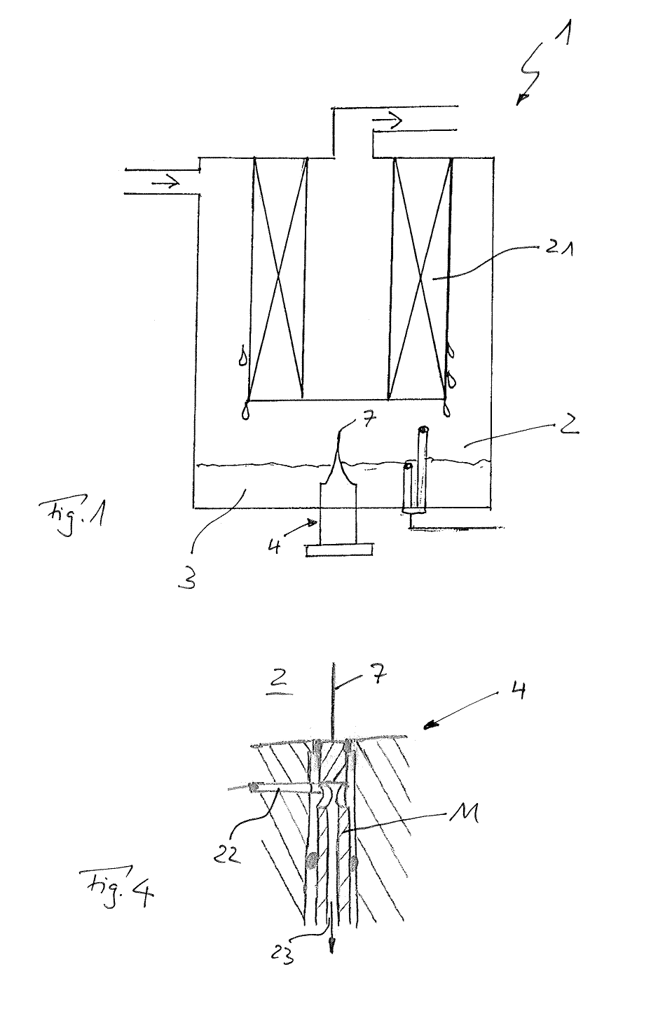

FIG. 1 shows a sectional view through a possible embodiment of a fluid filter according to the invention,

FIG. 2 shows a sectional view of the drain valve according to the invention,

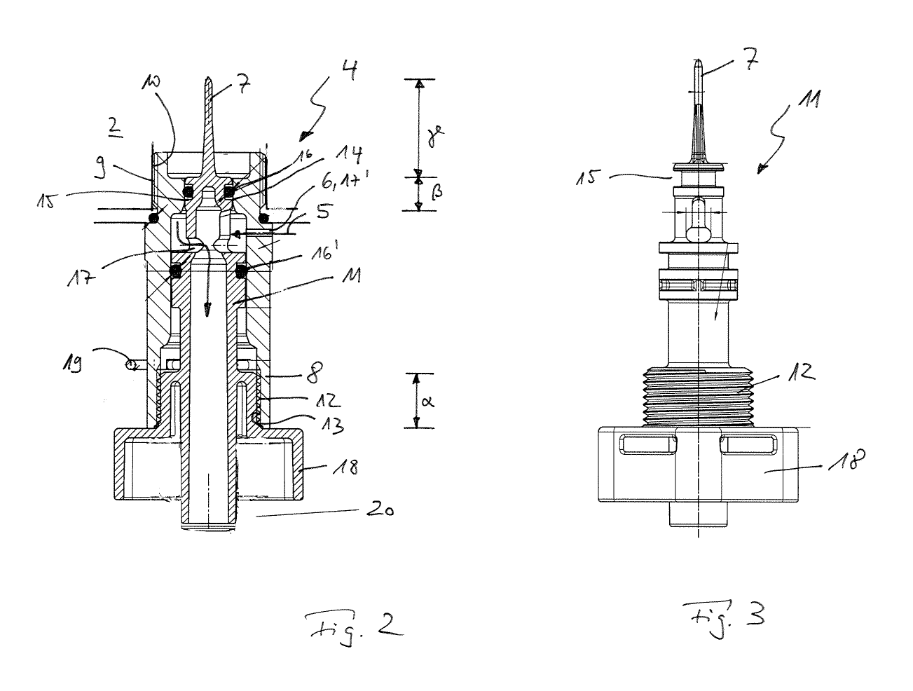

FIG. 3 shows a view of a valve piston of the draining valve,

FIG. 4 shows a further possible embodiment of an antenna-like drain valve according to the invention.

According to FIG. 1, fluid filter 1 according to the invention which, for example, in the concrete case is configured as fuel filter, comprises a collecting chamber 2, here a water collecting chamber 2 for collecting water 3 separated from the fluid. The description of the figures refers always to water collecting chamber 2, wherein it is of course conceivable that the same is configured as conventional collecting chamber 2 and, in general, a fluid is collected therein—thus not necessarily water 3. A fluid filter 1 in which a draining device 4, in particular a drain valve or a drain screw is arranged does not necessarily have to comprise a collecting chamber 2; it can also involve a fluid filter 1 which, e.g., requires draining the fluid so as to be able to change the filter element 21 filtering the fluid. It is also conceivable to provide the draining device 4 in other fluid containers within a vehicle. Of course, the fluid filter 1 can also be configured as urea filter or oil filter.

The fluid filter 1 illustrated in FIG. 1 has the water collecting chamber 2 on the crude side and the fluid to be cleaned flows from the outside inward through the filter element 21. Of course, the flow can also pass the other way round or the water collecting chamber can also be arranged on the clean side of the filter element 21. Preferably near the bottom or on the bottom side of the water collecting chamber 2, the draining device 4 is arranged by means of which the separated water 3 can be drained from the water collecting chamber 2. According to the invention, the draining device 4 allows in the open state that air 5 can flow in via an adequate air inlet 6 (cf. FIG. 2) and moreover, the draining device has an antenna-like, elongated protrusion 7 which projects into the water collecting chamber 2 and thus into the water 3 and, when being moved, reduces the surface tension of the water 3. By the protrusion 7 which projects into the water collecting chamber 2 and rotates or moves during opening, a surface of the water 3 is enlarged and the surface tension between the forces of the water molecules present on the surface of the water 3 and inside the water 3 is thereby reduced. Reducing the tension of water 3 allows a simple and fast draining of the separated water 3 from the water collecting chamber 2.

According to FIG. 2, the draining device 4 comprises a housing 8 with a first external thread 9 via which the latter can be screwed into a first internal thread 10 arranged in a wall of the water collecting chamber 2. Moreover, the draining device 4 comprises a valve piston 11 with a second external thread 12 which can be screwed into a second internal thread 13 arranged in a housing 8. The housing 8 can also be part of the filter housing of the fluid filter 1. Instead of an external thread 12, the housing 8 of the draining device 4 can be glued or welded into the filter housing of the fluid filter 1. The internal thread 13 too is not absolutely required; thereby, the draining device 4 is even easier to operate. However, it has to be ensured that during the operation, the draining device 4 closes the collecting chamber 2 tightly (not shown), for example by means of a locking element. Then, for emptying the collecting chamber 2, it is only necessary to remove the locking element and the draining device 4 releases the discharge opening.

When viewing FIG. 2 it is apparent that the housing 8 has a valve seat 14 in which the valve piston 11 having a valve section 15 is translationally displaceable by a rotational movement. The antenna-like, elongated protrusion 7 is arranged on the front side on the valve section 15 of the valve piston 11. For sealing between the valve section 15 and the valve seat 14, a first O-ring seal 16 is provided, whereas a second O-ring seal 16′ is arranged on the valve piston 11 and seals the same with respect to the housing 8 which is formed like a cylinder.

In order to allow a reliable draining of the water 3 from the water collecting chamber 2 without screwing the valve piston 11 completely out of the housing 8, an axial extension β of the valve seat 14 is smaller than an axial extension α of the second external thread 12. Moreover, an axial extension γ of the protrusion 7 is preferably at least twice as large, preferably three times as large as the axial extension β of the valve seat 14. Generally, the only important point here is that a sufficiently long path for moving the protrusion 7 and thus for disturbing and reducing the surface tension of the water 3 can be provided.

The valve piston 11 is preferably formed as pipe (channel) closed on one side and has at least one radial opening 17 arranged between the first O-ring seal 16 and the second O-ring seal 16′. Moreover, in the housing 8, a radial opening 17′ is provided as air inlet opening.

Generally, by reducing the surface tension of water 3 by the protrusion 7 according to the invention, a simplified draining of water 3 from the water collecting chamber 2 can be achieved, wherein this is caused by a reduction of the surface tension at a boundary surface as well as inside the water 3. Of course, the protrusion 7 does not have to have the embodiment shown according to the FIGS. 1 and 2 but can generally be configured as refraction head. Also, it is clear that the protrusion 7 does not have to have a tip to reduce the surface tension. The decisive factor for the disturbance of the surface and thus the reduction of the surface tension is the movement of the protrusion 7, wherein generally, the protrusion 7 can also have an irregular geometry. Also, the air inlet 6 can have not only a round shape but almost any shape. For example, the protrusion 7 can be tapered toward its free end and can have a star-shaped cross-section.

At the end facing away from the protrusion 7, the valve piston has a collar contour 18, via which a firm holding and rotating of the valve piston 11 is made possible. The collar contour 18 can preferably be configured in the form of an external hexagon or can be star-shaped. Possible dimensions for the protrusion 7 are approximately 21 mm for γ with a diameter of approximately 1.5 mm. It is conceivable to make the valve piston 11 and/or the housing 8 from plastic or metal.

In general, screwing the valve piston 11 out of the draining device 4 causes a rotation of the protrusion 7 on the surface of the separated water 3, whereby the surface tension of the water is reduced. Due to the rotation and the simultaneous stroke of the protrusion 7, an enlargement of the surface through adhesive forces at the refraction head of the protrusion 7 takes place, thereby making the draining of the water 3 easier.

As an example, the draining device 4 can also have the form illustrated in FIG. 2. Here, a gas inlet 22 or respectively, an air inlet 6 is formed into a wall surrounding the valve piston 11, and a fluid outlet channel 23 is formed into the valve piston 11.

1. A fluid filter comprising: a collecting chamber for collecting separated fluid and a draining device having an elongated protrusion projecting into the collecting chamber,
wherein the draining device, in response to being in an open state, allows air to flow into the collecting chamber for reducing a surface tension of the fluid.

2. The fluid filter according to claim 1,
wherein the draining device includes a housing with a first external thread for screwing into a first internal thread disposed on a wall of the collecting chamber.

3. The fluid filter according to claim 2,
wherein the draining device includes a valve piston with a second external thread for screwing into a second internal thread disposed on the housing.

4. The fluid filter according to claim 3,
wherein the housing has a valve seat and the valve piston has a valve section that is translationally displaceable by a rotational movement, and further wherein the protrusion is disposed on the valve section.

5. The fluid filter according to claim 4,
wherein the valve section of the valve piston carries a first O-ring seal for sealing the valve piston to the associated valve seat on the housing side.

6. The fluid filter according to claim 5,
further comprising a second O-ring seal disposed in a region of a piston shaft for sealing the valve piston to the housing.

7. The fluid filter according to claim 4,
further comprising an axial extension (β) of the valve seat being smaller than an axial extension (α) of the second external thread, wherein the draining device is fully opened before the valve piston can be removed from the housing.

8. The fluid filter according to claim 6,
wherein the valve piston is formed as a pipe being closed on one side and further wherein the valve piston defines at least one radial opening disposed between the first and the second O-ring seals.

9. The fluid filter according to claim 7,
further comprising an axial extension (γ) of the protrusion being at least twice as large as the axial extension (β) of the valve seat, and
wherein the housing defines a radial opening for receiving air flow.

10. A draining device comprising: an elongated protrusion projecting into a collecting chamber for reducing a surface tension of the fluid.

11. (canceled)

12. The draining device according to claim 10, wherein the draining device, in response to being in an open state, allows air to flow into the collecting chamber for reducing the surface tension of the fluid.

13. The draining device according to claim 12, wherein the draining device includes a housing with a first external thread for screwing into a first internal thread disposed on a wall of the collecting chamber.

14. The draining device according to claim 13, wherein the draining device includes a valve piston with a second external thread for screwing into a second internal thread disposed on the housing.

15. The draining device according to claim 14, wherein the housing has a valve seat and the valve piston has a valve section that is translationally displaceable by a rotational movement, and further wherein the protrusion is disposed on the valve section.

16. The draining device according to claim 15, wherein the valve section of the valve piston carries a first O-ring seal for sealing the valve piston to the associated valve seat on the housing side.

17. The draining device according to claim 16, further comprising a second O-ring seal disposed in a region of a piston shaft for sealing the valve piston to the housing.

18. The draining device according to claim 17, wherein the valve piston is formed as a pipe being closed on one side and further wherein the valve piston defines at least one radial opening disposed between the first and the second O-ring seals.

19. The draining device according to claim 18, further comprising an axial extension (γ) of the protrusion being at least twice as large as the axial extension (β) of the valve seat, and wherein the housing defines a radial opening for receiving air flow.

20. The draining device according to claim 15, further comprising an axial extension (β) of the valve seat being smaller than an axial extension (α) of the second external thread, wherein the draining device is fully opened before the valve piston can be removed from the housing.

21. The draining device according to claim 1, wherein the elongated protrusion is at least one of a drain valve and a drain screw to drain the separated fluid.
